(19) United States
(12) Patent Application Publication
(10) Pub. No.: US 2004/0139370 A1
(43) Pub. Date: Jul. 15, 2004

(54) Source code analysis

(76) Inventors: Dan Bailey, San Diego, CA (US); Mark Virnig, San Diego, CA (US); Doug Winter, Leucadia, CA (US); Kris Kelly, San Diego, CA (US); Liu Shishan, Beijing (CN); Gary Liu, Beijing (CN); Carol Zhang, Beijing (CN); Zhu Xihong, Beijing (CN); Lin Guoyong, Beijing (CN)

Correspondence Address: OBJECTIVE SOFTWARE SOLUTIONS, 171 Saxony Road, Suite 203, Encinitas, CA, 92024, US

(21) Appl. No.: 10/342,787

(22) Filed: Jan. 14, 2003

(51) Int. Cl. H04B 1/74

(52) U.S. Cl. 714/38

(57) ABSTRACT

A method includes determining that a source code statement violates an accessibility rule, and reporting a source code error corresponding to the determined violation of the accessibility rule. The method may also include identifying the source code statement from a source code file before determining that the source code statement violates an accessibility rule.

### TECHNICAL FIELD

This description relates to a process of determining whether a program may reduce accessibility to information for a user.

### BACKGROUND

As used herein, the term “computer system” refers to a physical machine having one or more processing elements and one or more storage elements in communication with the one or more processing elements. Each of the various user devices (e.g., computers) described herein include an operating system. The operating system is software that controls the computer system's operation and/or the allocation of resources. The term “process” or “program” refers to software, for example, an application program that may be executed on a computer system. The application program refers to the set of executable instructions, based on source code statements, that perform a task(s) desired by the user, using computer resources made available through the operating system.

A source code file includes source code statements written in a programming language, such as Visual Basic (VB), JAVA, C++, etc. Typically, a compiler program is used to convert the source code file into an executable program that includes machine language instructions executable by a computer processor. A computer system may be used to execute a compiled executable program. The executable program may allow information to be passed between a user and the computer system. For example, information may be passed between the user and computer system using conventional means such as a display device (e.g., a monitor, a screen) a keyboard, a mouse, a speaker, and/or a physical transducer (e.g., a microphone), etc. However, this is not meant to preclude the use of other mechanisms for passage of information between a user and a computer system.

Certain terms used throughout this specification and claims, although originating in the context of conventional visual displays, are intended to include corresponding functions in the context of other types of information delivery. For example, “Window” refers to any set of information available for presentation to a user through a graphical user interface (GUI). A “window” may include information displayed in a portion of a visual computer display, or may encompass the entire visual computer display. A GUI may cause the display of a “desktop”, which refers to a graphical work surface analogous to a surface of a desk. Windows may overlay the desktop, and the desktop display may include an icon(s) representing programs, files and/or resources available to the user. As such, the desktop acts as a launching point for running application programs, opening documents or files, displaying menus, and initiating operating system services.

A typical display window includes one or more “active” regions. The active regions are associated with instructions to be executed upon the occurrence of an event within an active region. For example, instructions associated with an active region may cause a jump to a specified location upon the occurrence of a mouse-click within the active region. Other events can also cause the execution of instructions. In particular, a detected movement of a mouse and/or an entry of a mouse pointer into an active region (in either case, with or without a click of a mouse button) are also events that may be used to trigger the execution of instructions associated with that region.

### DESCRIPTION OF THE DRAWINGS

FIG. 1 is a block diagram of computer hardware on which a process of source code analysis may be implemented.

FIG. 2 is a flowchart of a first embodiment of a source code analysis process.

FIG. 3 is a flowchart of a source code error report and display process.

FIG. 4 is a flowchart of a second embodiment of a source code analysis process.

FIG. 5 is a flowchart of a process for analyzing objects for accessibility.

### DESCRIPTION

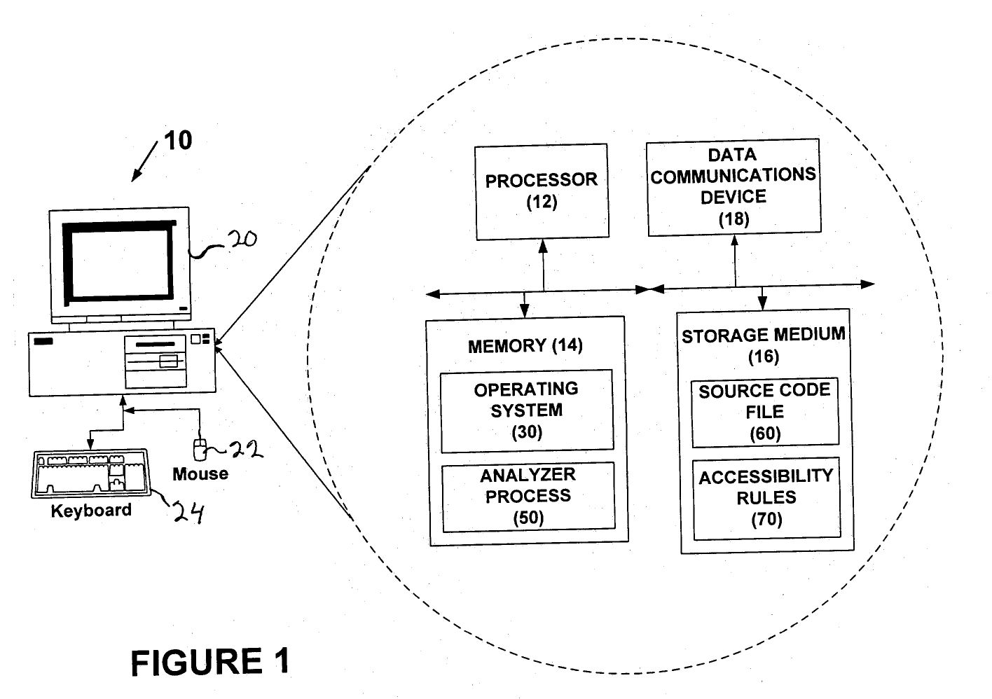

FIG. 1 depicts an exemplary computer system 10 that may be used to perform a source code analysis process. In this example, computer system 10 includes a processor 12, a memory (e.g., a random access memory) 14, a storage medium 16 (e.g., a hard drive, a floppy drive, etc.), a data communications device 18 (e.g., a modem, a network interface, etc.), a monitor 20 (e.g., CRT, LCD display, etc.), a mouse pointing device 22 and a keyboard 24. Computer system 10 usually operates under the control of an operating system 30. Storage medium 16 may be used to store data and/or machine-executable instructions that are executed by processor 12 from memory 14 to perform user device functions.

An analyzer process 50 (e.g., a program) may be executed from memory 14 to perform an analysis of a source code file 60 to determine whether any source code statements included in source code file 60 may cause a reduction in accessibility to information for a user of a program based on source code file 60. Analyzer process 50 may be used to determine whether a software program violates an accessibility rule(s) 70 related to the output of information to a display device, and/or the input of information from an input device associated with the display device. Accessibility rules 70 may relate to source code statements that affect visual outputs (e.g., source code that may affect the display/output of images or text), audible outputs (e.g., source code that may affect sound outputs), speech inputs/recognition (e.g., code that may affect the input of commands and/or data associated with a spoken word), and inputs from a user-controlled device (e.g., code that may affect the ways that input areas on a display screen are displayed and the types of actions a user must undertake to select and enter information into the input area).

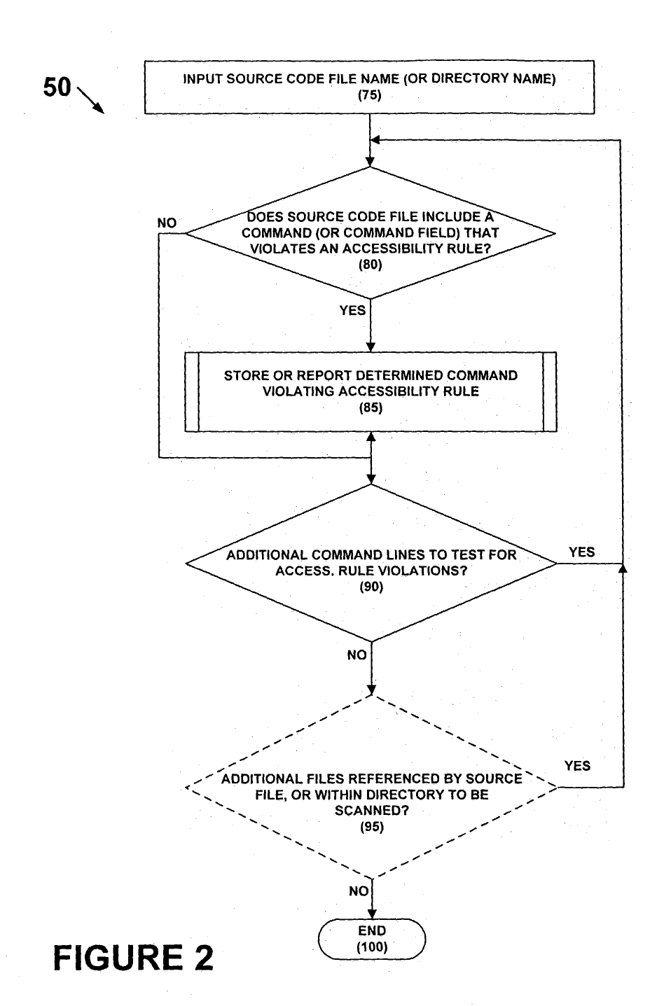

FIG. 2 depicts a flowchart of analyzer process 50 that may be performed to analyze source code file 60 for violations of accessibility rules 70. As will be explained in greater detail, accessibility rules 70 refer to a rule(s) that defines a source code statement(s) (or a combination of source code statements) that may reduce accessibility to information by a user(s) having a disability when executing a program corresponding to source code file 60. Process 50 includes inputting (75) a source code file name (or directory name), determining (80) whether the source code file includes a command line statement that violates an accessibility rule 70 (a “source code error”), and, through sub-process 85, storing and/or reporting (85) any determined violations to a user of process 50. Process 50 include determining (90) if additional command lines are available to test for accessibility rule violations, and optionally includes determining (95) whether additional files referenced by source code file 60 or related to the directory name are available for analysis by process 50.

Process 50 performs an analysis of a source code file, and, therefore, does not require execution of an executable file corresponding to the source code file to determine an accessibility rule violation. Moreover, performance of process 50 does not require a user to interact with the analysis tool in “real-time”, rather the user may cause the execution of process 50 and review the results of the analysis at a later time.

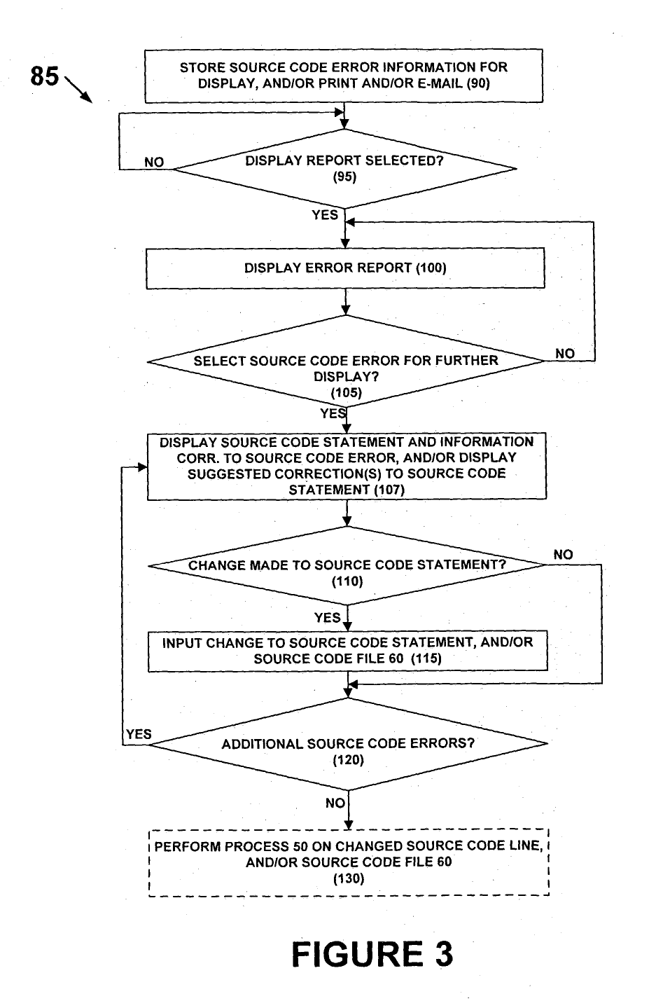

FIG. 3 depicts a flowchart of sub-process 85 that may be performed to store, report and/or display a source code error, a source code statement(s), and/or a suggested correction to a source code line. Sub-process 85 includes storing (90) the determined source code error for display, report or forwarding to a user, determining (95) whether a display of an error report (e.g., a display of a rule violation summary corresponding to the source code accessibility error) has been selected, and displaying (100) the error report on a user device. Sub-process 85 includes determining (105) whether the user has selected a display of the source code statement corresponding to the source code accessibility error and/or a display of a suggested correction to that source code statement, and displaying (107) a report based on the user selection. Sub-process 85 includes determining (110) whether a correction/edit has been made to the displayed source code statement, and inputting that correction/edit to the source code statement (e.g., to source code file 60), and determining whether additional source code statements corresponding to source code accessibility error are available for display. Sub-process 85 optionally includes performing (130) process 50 to analyze the corrected/edited source code statement and/or source code file 60.

Sub-process 85 allows a user to easily display reports of source code accessibility error(s), and/or source code statements and/or suggested corrections corresponding to source code accessibility error(s). In this way, a user can ensure that an application based upon source code file 60 will be in compliance with accessibility rules 70. Moreover, through repetitive use of process 50, and/or sub-process 85, a user may learn to identify types source code statement(s) (or combinations of source code statements) that may cause accessibility rule violations, the learning may reduce the time required to produce accessibility rule compliant code in subsequent programming produced by the user.

Accessibility rules 70 are usable to ensure that a program corresponding to a source code file allows a user having a disability access to information that is comparable to the access and use by a user without a comparable disability (e.g., accessibility rules are usable to determine source code instructions that may reduce access to information for a user having a disability.) Accessibility rules 70 refer to a rule(s) that define a source code statement(s) (or a combination of source code statements) that may reduce accessibility to information by a user(s) having a disability when executing a program corresponding to source code file 60.

In an embodiment, accessibility rules 70 may be based on suggested accessibility standards related to §508 of the Rehabilitation Act of 1973, as amended (29 United States Code §794d). §508 of the Rehabilitation Act of 1973, as amended, is hereby incorporated by reference. §508 requires that when Federal agencies develop, procure, maintain, or use electronic and information technology, users with disabilities have access to and use of information and data that is comparable to the access and use or a user who do not have a comparable disability. §508 also requires that individuals with disabilities, who are members of the public seeking information or services from a Federal agency, have access to and use of information and data that is comparable to that provided to the public who are not individuals with disabilities. The purpose of the suggested accessibility standards related to §508 is to build as much accessibility as is reasonably possible into general products developed, procured, maintained, or used by Federal agencies.

The following examples describe accessibility standards that may be the basis for related accessibility rule(s) 70.

As a first example, menu functions in a drawing program may allow a user to open, save, size, rotate, and/or perform an action(s) on a graphic image by interacting with a mouse (e.g., a pointing device). A user with a disability that affects dexterity may find it difficult or impossible to move the mouse with sufficient accuracy to activate features presented by the drawing program. Another user who is able to move the mouse adequately may be unable to see the computer display screen to determine what is being pointed to when the mouse is moved. Therefore, a related accessibility rule may include determining whether a keyboard shortcut is included in a program to a function identified with a text label.

As a second example, a graphical toolbar may include a visual shortcut to a function that may also exist in a menu structure of a program. In more detail, a scroll function may have a keyboard alternative, such as the use of the “Page Up”, and/or “Page Down” keys to access the scroll function. If the function activated by the control on a toolbar is a duplicate of a menu function that already has a keyboard shortcut then the toolbar control does not need its own keyboard access. Therefore, an accessibility rule may include determining if a function depicted on a graphical toolbar is unique and requiring that the function have an associated keyboard shortcut.

As a third example, some applications and/or operating systems have identified accessibility features. Typically, these identified accessibility features may be turned on or off by a user, for example, identified accessibility features may include reversing a color scheme (to assist people with low vision), showing a visual prompt when an error tone is sounded (to assist persons who are deaf or hard of hearing), and/or providing a “sticky key” that allows a user to press a key combination (such as “Control-C”) sequentially rather than simultaneously (to assist persons with dexterity disabilities). Therefore, an accessibility rule may include a rule prohibiting an application from disabling an identified accessibility feature when activated prior to executing the application.

As a fourth example, an accessibility rule may require an application not use flashing and/or blinking text, objects, or elements (e.g., flashing and/or blinking within a specific frequency range.) This accessibility rule is in consideration of those users who may have photosensitive conditions (e.g., photosensitive epilepsy).

As a fifth example, an application may use electronic forms. A related accessibility rule may require that keyboard alternatives be provided for navigating through the electronic form, and/or elements of the electronic form are labeled with associated text located relatively close to each field that is to be completed. For example, if a checkbox is displayed, an associated text label must be available to indicate what is being checked, and the current status of the checkbox (e.g., checked or unchecked).

As a sixth example, an application may allow a user to select a system setting that affects an output of a computer (e.g, a display color, and/or contrast level) or an input to the computer (e.g., a keyboard repeat rate, and/or keyboard sensitivity). If another application disables these system settings, accessibility may be affected. Therefore, a related accessibility rule may require an application to use a user-selected system setting(s) and not over-ride those setting(s) during execution of the application.

Accessibility rules 70 may also refer to a rule(s) that determines whether a source code statement(s) may interfere with the operation of a so-called “assistive technology” feature included in an application. Assistive technology refers to features included in an application for a user with a disability to provide program accessibility. For example, assistive technology may refer to an included feature to cause a Braille display, or an included feature that causes an audible output(s) based on computer screen display information.

The following examples describe accessibility rule(s) that may be included in accessibility rules 70 and based on assistive technology requirements.

As a first example, a position on a display screen where an action may occur may be referred to as the “focus”. For example, when a menu item displayed by a program is highlighted, if a user clicks a mouse or presses a key, a function related to the item displayed will activate and that item has the “focus”. In this case, providing a visual indication of the focus allows a user who is viewing the screen to more accurately access the programs' features. A related accessibility rule may require that the position of a programs' focus be made available to assistive technology, e.g., a defined indication of the current focus shall be provided that moves among elements as the input focus changes.

As a second example, text may be associated with a user interface element, e.g., text may be associated with a button, a menu, a toolbar, a scroll bar, etc. The associated text may an action that may be performed by selection of the element. A related accessibility rule may include requiring a program that causes a display of an element with associated text also output information to identify the element, its state, so that an assistive technology may process the associated text information

As a third example, when programs are written using unique schemes for displaying text on a display screen and/or use graphics, assistive technology may not be able to interpret the unique schemes. Therefore, a related accessibility rule may require that when a unique scheme of displaying text is used, the text should also be made available to the operating system (e.g., the text is also written to the written to the screen through an operating system API).

As a fourth example, when elements such as buttons and/or text are animated, an assistive technology application may not be able to access information related to animation. Therefore, a related accessibility rule may require that if an application uses animation that there is also an option to turn off the animation, or when the animation is displayed the information depicted by the animation shall also be available (e.g., displayable) in at least one non-animated presentation mode.

As presented below, Examples 1-24 depict exemplary accessibility rules and/or determinations that may be used when analyzing a source code statement(s) written in VisualBasic (VB).

### EXAMPLE 1

Rule: Menu items should have keyboard shortcuts.

Determination: Scan the “Caption” values in “Begin VB.Menu” to see whether they have “&”.

Comment: If the menu caption is assigned during runtime by using “Caption=”, scan the string after the “=” to ensure that “&” is included, or whether “LoadResString” is used and its corresponding string in RES file have “&”.

### EXAMPLE 2

Rule: Dialog box fields should be tab-able (in order)

Determination: Scan “Begin VB.TextBox” to see whether they have the “TabStop=0”.

Determination: Scan “Begin VB.TextBox” in the same “Begin” Level and get all the values of “TabIndex”,“Left”,“Top” to see whether the value of “TabIndex” increased from Left to Right, and from Top to Bottom.

### EXAMPLE 3

Rule: Dialog box buttons should have keyboard shortcuts.

Determination: Scan the “Caption” values in “Begin VB.CommandButton” to see whether they have “&”.\

### EXAMPLE 4

Rule: The API of SystemParametersInfo that may change the accessibility features should be carefully used.

Determination: Scan the source code for Windows APIs that deal with Windows “sticky keys”, “slow keys”, and “repeat keys”. If such APIs are present, provide an error message or a warning in the report.

### EXAMPLE 5

Rule: Label text should end with a colon (:) as required by Assistive Technology.

Determination: Scan source code and Windows resource files for label text and ensure that they end with a colon (:) as required by Assistive Technology. And/or scan the values of “Caption” in “Begin VB.Label” contain “:”.

### EXAMPLE 6

Rule: All Windows and Dialog boxes should have titles.

Determination: Scan all the caption properties of Window or Dialog box control to check whether they have values.

### EXAMPLE 7

Rule: If the VB application dynamically created the window or dialog box label when running, scan window or dialog box controls (may be menu control array) to see whether caption(s) have associated values.

### EXAMPLE 8

Rule: Bitmaps and other graphics should include alternative text.

Determination: Scan source code to ensure that bitmaps and other graphics include alternative text.

### EXAMPLE 9

Rule: Some textual output should be produced when audio output is presented and has an especial meaning.

Determination: Scan source code for audio output (e.g., beeps) and ensure that some textual output is also produced. And/or scan source code for Windows APIs related to “show sounds”. Produce a warning message in the report if this is not present.

### EXAMPLE 10

Rule: The default background color and foreground color of a form should not be changed by an application.

Determination: Scan for form control's “BackColor”, “ForeColor” value. And/or scan “Line . . . BF” in the form control.

### EXAMPLE 11

Rule: The properties of “ForeColor”, “FontName”, “FontBold”, “FontItalic”, “FontSize” of a label should be carefully used. The native windows text output mechanisms should not be changed.

Determination: Scan source code for Windows APIs related to changing the text fonts for display and printing. If not found, put an error message into the report.

Determination: Scan all Label control's “ForeColor”, “FontName”, “FontBold”, “FontItalic” “FontSize”

### EXAMPLE 12

Rule: Graphics should not be flashing or rotating.

Determination: Scan source code for Windows APIs related to flashing and rotating graphics. Put an error message into the report if these are detected.

### EXAMPLE 13

A well defined on-screen indication of the current focus shall be provided that moves among interactive interface elements as the input focus changes. The focus shall be programmatically exposed so that assistive technology can track focus and focus changes.

### EXAMPLE 14

Rule: At least an input field in a form should have the “setFocus” method.

Determination: Form which has a TextInput, Combox, TextArea, CheckBox, RadiaoButton fields should have “SetFocus” method.

### EXAMPLE 15

Rule: Sufficient information about a user interface element including the identity, operation, and state of the element shall be available to assistive technology.

Determination: Icons should have associated text as well as support of tool tips.

### EXAMPLE 16

Rule: Each icon on the tool bar should have tool tip.

Rule: Button, checkbox, radio button and menus should have a related text to describe themselves.

Determination: Scan source code for user interface elements that include button, checkboxes, menus and ensure that related text is also provided.

### EXAMPLE 17

Rule: When bitmap images are used to identify controls, status indicators, or other programmatic elements, the meaning assigned to those images shall be consistent throughout an application's performance.

### EXAMPLE 18

Rule: Images used to identify same programmatic elements shall be consistent throughout an application's performance.

Determination: Scan source code for customer bitmaps, and other graphic items, and provide an informational message in the report.

### EXAMPLE 19

Rule: Textual information shall be provided through operating system functions for displaying text. The minimum information that shall be made available is text content, text input caret location, and text attributes.

### EXAMPLE 20

Rule: The API of “SetSysColors” should be carefully used.

Determination: Scan source code to check whether “SetSysColors” is used, give warning message if found.

### EXAMPLE 21

Rule: When animation is displayed, the information shall be displayable in at least one non-animated presentation mode at the option of the user.

Determination: Scan source code from Windows animation APIs and ensure that an alternative non-animated option is also provided.

### EXAMPLE 22

Rule: Color-coding shall not be used as the only means of conveying information, indicating an action, prompting a response, or distinguishing a visual element.

Determination: Scan source code for the use of different text foreground and background colors. Provide an informational message where they are found. And/or ensure Label.ForeColor is not used.

### EXAMPLE 23

Rule: Software should avoid using flashing or blinking text, objects, or other elements having a flash or blink frequency greater than 2 Hz and lower than 55 Hz.

Determination: Scan source code for the Windows API dealing with flashing/blinking and ensure that only appropriate frequencies are used.

### EXAMPLE 24

Rule: When electronic forms are used, the form shall allow people using assistive technology to access the information, field elements, and functionality required for completion and submission of the form, including all directions and cues.

Determination: Escape Key/Return Key should be used to cancel/submit the electronic form. And/or scan the code to determine whether “txtField_KeyPress ( )” event has a vbKeyReturn (or 13) and vbKeyEscape (or 27), or at a Button's default value is True (Example: cmdCommit.Default=True)

As presented below, Examples 25-36 depict exemplary accessibility rules and/or determinations that may be used when analyzing a source code statement(s) written in Java.

### EXAMPLE 25

Rule: When software is designed to run on a system that has a keyboard, product functions shall be executable from a keyboard where the function itself or the result of performing a function can be discerned textually.

Rule: All menu items should have keyboard shortcuts.

Determination: Menus support two kinds of keyboard alternatives: mnemonics(with setMnemonic method or when constructing the object) and accelerator(with setAccelerator method ). All menu items (JMenu/JMenuItem/JRadioButtonMenuItem/JCheckBoxMenuItem) support at least one kind.

### EXAMPLE 26

Rule: All dialog box fields should be tab-able (in order).

Determination: Box fields (except the ones which are tab-unable) set by setEnabled(false) method ) are tab-able and the order is from Left to Right, and from Top to Bottom.

### EXAMPLE 27

Rule: All dialog box buttons should have keyboard shortcuts and all image-only buttons should have accessible descriptions.

Determination: Scan Buttons(JButton/JCheckBox/JRadioButton/JToggleButton) to determine if keyboard alternatives available/set with the setMnemonic method.

### EXAMPLE 28

Rule: Toolbar(s): F10 should be reserved and used for moving focus to the menu bar.

Determination: Scan code to determine if any menu use of F10 as an accelerator.

### EXAMPLE 29

Rule: Applications shall not disrupt or disable activated features of other products that are identified as accessibility features where those features are developed and documented according to industry standards.

Determination: Scan Windows and Dialog boxes to determine if they have titles (e.g., in Java there are 5 kind of windows: JDialog or Dialog, FileDialog, JFrame or Frame, JoptionPane).

### EXAMPLE 30

Rule: Textual output should be produced when audio output is presented and has an especial meaning.

Determination: Scan the lines nearby “Beep” method whether a text display method can be found.

### EXAMPLE 31

Rule: Sufficient information about a user interface element including the identity, operation, and state of the element shall be available to assistive technology. Foe example, icons should have associated text as well as support of tool tips.

Determination: Scan code to find out the AWT class which has a corresponding class in Swing, give Warning message if found.

### EXAMPLE 32

Rule: When bitmap images are used to identify controls, status indicators, or other programmatic elements, the meaning assigned to those images shall be consistent throughout an application's performance. Images used to identify same programmatic elements shall be consistent throughout an application.

Determination: Scan source code for customer bitmaps, and other graphic items, and provide an informational message in the report.

### EXAMPLE 33

Rule: Textual information shall be provided through operating system functions for displaying text. The minimum information that shall be made available is text content, text input caret location, and text attributes. The drawstring method of the Graphics/Graphics 2D object should not be used.

Determination: Scan source code for text handling to ensure no use of “drawString(word, x, y)” of Graphics/Graphics 2D object.

### EXAMPLE 34

Rule: Applications shall not override user-selected contrast and color selections and other individual display attributes. The default Background color of the JFrame or JPane object should not be changed.

Determination: Check to see whether JFrame or JPanel change its default color. And/or Scan for “setBackground”, “setForeground” method the components of JFrame, JPanel, Frame, Panel, Label, JLabel etc.

### EXAMPLE 35

Rule: When animation is displayed, the information shall be displayable in at least one non-animated presentation mode at the option of the user.

Determination: Scan the code for the following API:

1. *. AVI is played

2. import javax.media.*

createplayer( ) or createRealizedPlayer( )

getVisualComponent( )

### EXAMPLE 36

Rule: When electronic forms are used, the form shall allow people using assistive technology to access the information, field elements, and functionality required for completion and submission of the form, including all directions and cues. Escape Key/Return Key should be used to cancel/submit the electronic form.

Determination: Scan the code to find JDialog and JFrame components: Ensure JTextField and JtextArea has “addActionListener(this)”.

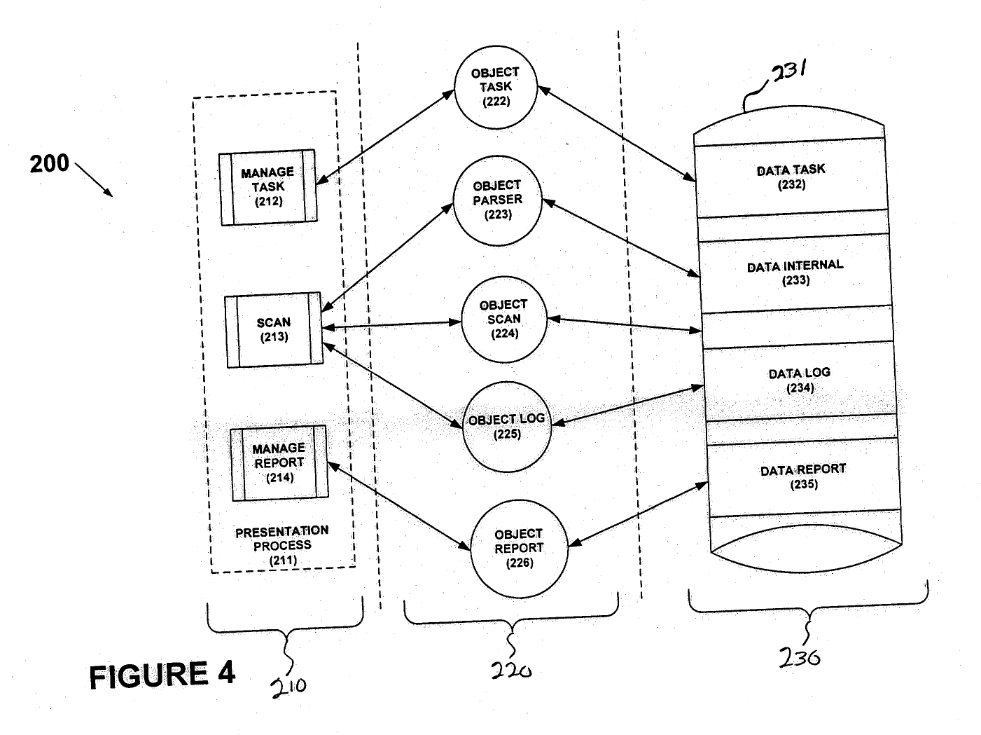

FIG. 4 depicts a second embodiment of a source code analysis process 200. Process 200 is presented as a three-layer process including a first layer 210, a second layer 220 and a third layer 230. First layer 210 represents a presentation layer that includes sub-processes 212-214 to present information to a user of process 200, receive commands and data from the user and report/display information related to determined source errors. Second layer 220 represents an analysis layer to analyze source code statements and determine any source code error(s) included in an internal data file 233 (e.g., a source code file). Third layer 230 represents a data storage/retrieval layer to store and/or retrieve task information, accessibility rules, internal data file(s) interim results and source code error information as part of a report log on a data storage device 231. In this example of process 200, second layer 220 includes objects 222-226. Objects 222-226 may represent object-oriented programs that typically include a description of a set of data from database 231, as well as object references and attributes. Each object may also include “methods” (e.g., instructions or logical sequences) to manipulate the data included in the object. Objects 222-226 are used to perform functions when commands and/or data are received from a sub-process 212-214. For example, object task 222 receives and stores information in data task file 232 related to an analysis of a source code file, object parser 223 and object scan 224 perform a parsing and/or a scan of data internal file 233 to determine accessibility rule violations in source code statement(s), object log 225 stores source code error information in data log file 234 and object report stores and retrieves information related to determined source code errors, the information being displayable on a computer display.

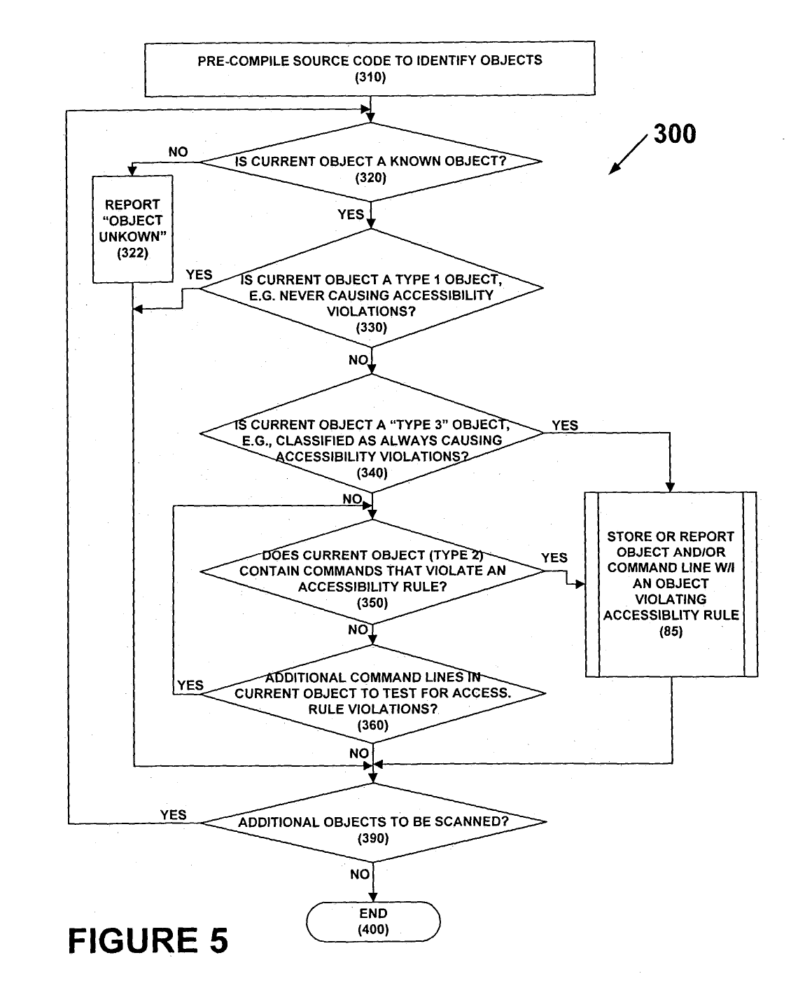

FIG. 5 depicts a process 300 that may be performed to analyze objects for accessibility rule violations (“rule violations”). Process 300 includes pre-compiling (310) a source code file to identify object(s) that may cause rule violations when executed. The identified objects may then be compared to objects that have been classified, for example, objects classified as causing rule violations all of the time (“Type 3”), some of the time (“Type 2”), or never (“Type 1”). The object classification data may be stored on a database accessible to a computer performing process 300. Process 300 includes determining (320) whether the current identified object is a known object (e.g., included in the classification database), and reporting (322) the current object as an “unknown object” to the user if the object is not determined as a known object. If the current object is determined to be a known object, process 300 includes determining (330) if the current object is a Type 1 object (e.g., never causing rule violations), and if the current object is determined to be a Type 1 object, determining (390) if additional objects are available for scanning. If the current object is determined (330) not to be a Type 1 object, process 300 includes determining (340) if the current object is a Type 3 object (e.g., an object classified as always causing a rule violation), and storing (85) or reporting the current object if it is determined to be a Type 3 object. If the current object is determined not to be a Type 3 object, process 300 includes determining (350) if the current object contains commands that violate an accessibility rule, and storing (85) or reporting any command lines determined to violate an accessibility rule. Process 300 includes determining (360) if additional command lines in the current object for testing for accessibility rule violations, and if there are not additional command lines for testing, determining (390) if additional objects are identified for scanning (e.g., performing process 300 again to determine additional object(s) that may cause accessibility violations).

User devices and/or host computer are not limited to use with the hardware and software of FIG. 1. It may find applicability in any computing or processing environment. They may be implemented in hardware, software, or a combination of the two. They may be implemented in computer programs executing on programmable computers or other machines that each include a processor, a storage medium readable by the processor (including volatile and non-volatile memory and/or storage components), at least one input device, and one or more output devices. Program code may be applied to data entered using an input device (e.g., a mouse or keyboard) to perform applications and to generate output information.

Each computer program may be stored on a storage medium/article (e.g., CD-ROM, hard disk, or magnetic diskette) that is readable by a general or special purpose programmable computer for configuring and operating the computer when the storage medium or device is read by the computer to perform applications. They may also be implemented as a machine-readable storage medium, configured with a computer program, where, upon execution, instructions in the computer program cause a machine to operate in accordance with those applications.

The invention is not limited to the specific embodiments described above. For example, source code program 60 and accessibility rules file 70 are generally stored in a file on a data storage device, such as data storage device 16, or may be read from a data communications device, such as data communications device 18, or may be entered interactively by a user from an input device, such as keyboard 24.

Other embodiments not described herein are also within the scope of the following claims.

What is claimed is:

1. A method comprising:
determining that a source code statement violates an accessibility rule; and
reporting a source code error corresponding to the determined violation of the accessibility rule.

2. The method of claim 1, wherein determining further comprises:
identifying the source code statement from a first source code file before determining that the source code statement violates an accessibility rule.

3. The method of claim 1, further comprises:
storing the source code error in a database; and
storing associated information related to the source code error in the database.

4. The method of claim 1, further comprises:
presenting the source code statement corresponding to the source code error.

5. The method of claim 3, further comprises:
presenting a suggested correction corresponding to the source code statement.

6. The method of claim 3, further comprises:
receiving a change to the source code statement; and
re-determining whether the changed source code statement violates an accessibility rule.

7. The method of claim 1, further comprises:
storing a set of accessibility rules in a database.

8. The method of claim 7, wherein at least one of the set of accessibility rules comprises a textual string that may be compared to a source code statement.

9. The method of claim 7, wherein at least one of the set of accessibility rules comprises a combination of textual strings that may be compared to the source code statement.

10. The method of claim 2, further comprises:
determining a second source code file for a rule violation determination, the second source file referenced by the first source code file.

11. The method of claim 2, further comprises:
determining a second source code file for a rule violation determination, the second source code file included in a directory associated with the first source code file.

12. A method comprising:
compiling a source code file;
identifying an object produced by the compiling of the source code file; and
determining that the object matches an object classification, wherein the classification represents at least one of an object that may violate an accessibility rule, an object that does violate an accessibility rule, and an object that does not violate an accessibility rule.

13. The method of claim 12, further comprises:
reporting the matched object as an object corresponding to an object that may cause an accessibility violation.

14. The method of claim 12, further comprises:
storing information corresponding to the matched object in a database.

15. An article comprising a storage medium having stored thereon instructions that when executed by a machine results in the following:
compile a source code file;
identify an object produced by the compiling of the source code file; and
determine that the object matches an object classification, wherein the classification represents at least one of an object that may violate an accessibility rule, an object that does violate an accessibility rule, and an object that does not violate an accessibility rule.

16. The article of claim 15 further comprises instructions that when executed by a machine results in the following:
report the matched object as an object corresponding to an object that may cause an accessibility violation.

17. The article of claim 15, further comprises instructions that when executed by a machine results in the following:
store information corresponding to the matched object in a database.

18. An article comprising a storage medium having stored thereon instructions that when executed by a machine results in the following:
determine that a source code statement violates an accessibility rule; and
report a source code error corresponding to the determined violation of the accessibility rule.

19. The article of claim 18, wherein determining further comprises instructions that when executed by a machine results in the following:
identify the source code statement from a first source code file before determining that the source code statement violates an accessibility rule.

20. The article of claim 18, further comprises instructions that when executed by a machine results in the following:
store the source code error in a database; and
store associated information related to the source code error in the database.

21. The article of claim 18, further comprises instructions that when executed by a machine results in the following:
present the source code statement corresponding to the source code error.

22. The article of claim 18, further comprises instructions that when executed by a machine results in the following:
present a suggested correction corresponding to the source code statement.

23. The article of claim 20, further comprises instructions that when executed by a machine results in the following:
receive a change to the source code statement; and
re-determine whether the changed source code statement violates an accessibility rule.

24. The article of claim 18, further comprises instructions that when executed by a machine results in the following:
store a set of accessibility rules in a database.

25. The article of claim 24, wherein at least one of the set of accessibility rules comprises a textual string that may be compared to a source code statement.

26. The article of claim 19, further comprises instructions that when executed by a machine results in the following:
determine a second source code file for a rule violation determination, the second source code file referenced by the first source code file.

27. The article of claim 19, further comprises:
determining a second source code file for a rule violation determination, the second source code file included in a directory associated with the first source code file.
